(19) United States
(12) Patent Application Publication
(10) Pub. No.: US 2025/0381465 A1
(43) Pub. Date: Dec. 18, 2025

(54) SENSING BALL LAUNCHER

(71) Applicant: HANLAN TECHNOLOGY (HUIZHOU) CO., LTD, HUIZHOU CITY (CN)

(72) Inventors: ZHIFENG XIAO, HUIZHOU CITY (CN); JUN XIAO, HUIZHOU CITY (CN)

(21) Appl. No.: 19/226,167

(22) Filed: Jun. 3, 2025

Related U.S. Application Data
(63) Continuation-in-part of application No. 18/797,452, filed on Aug. 7, 2024.

(30) Foreign Application Priority Data
Jun. 14, 2024 (CN) 202410774314.0
Apr. 24, 2025 (CN) 2025208016285

(51) Int. Cl. A63B 69/40; A01K 15/02

(52) U.S. Cl. CPC A63B 69/406; A01K 15/025; A63B 2220/10

(57) ABSTRACT

A sensing ball launcher relates to the technical field of pet toys, including a housing, a ball-launching device, a first sensor, and a controller. The housing includes a ball entry port, a ball exit port, and a ball feeding channel disposed inside the housing and communicating the ball entry port and the ball exit port. The ball-launching device is disposed in the housing and includes a driving member and a ball-launching assembly, which is mechanically coupled to the driving member and partially extends into the ball feeding channel to launch a ball through the ball exit port. The first sensor is disposed on the housing and configured to detect mechanical vibrations of the housing caused by external forces. The controller is disposed inside the housing, signal-connected to the first sensor and electrically connected to the driving member, and controls the ball-launching assembly based on a sensing signal.

### FIELD OF THE DISCLOSURE

The present disclosure relates to the technical field of pet toys, specifically to a sensing ball launcher.

### BACKGROUND OF THE DISCLOSURE

With socio-economic development and the improvement of living standards, pets have gradually become important members of many families. To meet their daily exercise and entertainment needs, a variety of pet toys and intelligent interactive devices have emerged on the market. Among these, automatic ball launchers—intelligent devices designed to encourage pets' independent activity—have gained increasing popularity among pet owners.

Conventional pet ball launchers usually include a housing, a ball entry port and a ball exit port provided on the housing, a ball feeding channel connecting the two ports, a driving motor disposed inside the housing, and one or more ball-launching wheels mechanically coupled to the driving motor. When there is a ball in the ball feeding channel, the ball-launching wheels can launch the ball from the ball exit port. However, such technical solutions have some deficiencies. For example, existing pet ball launchers often cause the driving motor to continuously drive the ball-launching wheels during operation, which not only wastes energy but also generates noise, adversely affecting the battery endurance of the product and reducing the comfort level for both humans and pets.

Accordingly, there remains a need for a sensing ball launcher that can reduce energy consumption, extend battery life, and lower operational noise.

### SUMMARY OF THE DISCLOSURE

The objective of the present disclosure is to overcome the deficiencies of the prior art by providing a sensing ball launcher that addresses at least one of the identified technical problems and offers benefits such as reduced energy consumption, extended battery life, and lower operational noise.

In order to achieve the purpose, the present disclosure provides a sensing ball launcher, comprising: a housing having a ball entry port, a ball exit port, and a ball feeding channel disposed inside the housing and communicating the ball entry port and the ball exit port; a ball-launching device disposed inside the housing and comprising a driving member and a ball-launching assembly mechanically coupled to the driving member, wherein the ball-launching assembly partially extends into the ball feeding channel and is configured to launch a ball from the ball exit port; a first sensor disposed on the housing and configured to detect mechanical vibrations of the housing caused by external forces; a controller disposed inside the housing, signal-connected to the first sensor and electrically connected to the driving member, and configured to control a movement of the ball-launching assembly based on a sensing signal from the first sensor.

Optionally, the housing comprises a ball guide funnel having a diameter that gradually narrows from an edge toward the ball entry port, the ball guide funnel is configured to receive a ball and guide the ball to the ball entry port; and the first sensor is at least one vibration sensor disposed on an inner wall of the ball guide funnel, and configured to sense mechanical vibrations caused by the falling of the ball.

Optionally, an auxiliary remote controller is further comprised, wherein the auxiliary remote controller is signal-connected to the controller and configured to remotely override and control an operation of the ball-launching device.

Optionally, a ball-blocking assembly is further disposed inside the housing at a position adjacent to the ball entry port, and is electrically connected to the controller, wherein the ball-blocking assembly is configured to extend into the ball feeding channel to block the passage of a ball, or retract to allow the passage of a ball.

Optionally, the ball-blocking assembly comprises: an electric push rod disposed inside the housing; and a blocking plate fixedly connected to a push rod of the electric push rod, wherein a curved surface of an extending end of the blocking plate matches a curved contour of an inner wall of the ball feeding channel.

Optionally, the ball-launching assembly comprises two ball-launching wheels symmetrically disposed on two sides of the ball feeding channel; the driving member comprises two driving motors, and each of the two driving motors is mechanically coupled to one of the ball-launching wheels; and the ball-launching wheels partially extend into the ball feeding channel to launch the ball from the ball exit port.

Optionally, the ball-launching device further comprises: a wheel seat mounted on an outer wall of the ball feeding channel and comprising two wheel grooves symmetrically provided on two sides of the ball feeding channel for accommodating the ball-launching wheels; and a wheel cover mounted over the wheel seat and covering at least part of the ball-launching wheels; wherein the driving motors are mounted outside the wheel cover, and output ends thereof pass through the wheel cover and are fixedly connected to the ball-launching wheels.

Optionally, the sensing ball launcher further comprises a second sensor disposed inside the housing and electronically connected to the controller, and configured to sense whether a person or an animal is approaching the ball exit port region.

Optionally, the ball entry port is disposed on an upper end of the housing, and the ball exit port is disposed on a side of the housing; the ball feeding channel extends downwardly from the ball entry port, and then upwardly to the ball exit port; a control panel is disposed on a peripheral wall of the housing at a side opposite to the ball exit port.

Optionally, a chassis of the housing has an upwardly protruding structure, and an arcuate recess that curves upwardly is formed on the peripheral wall of the housing at the side of the ball exit port and the control panel.

Compared with the prior art, the advantages of the present disclosure are as follows.

Since the sensing ball launcher is provided with a first sensor disposed on the housing and configured to detect mechanical vibrations of the housing caused by external forces, and the housing is further provided with a controller that is signal-connected to the first sensor and electrically connected to the driving member, the controller controls the movement of the ball-launching assembly based on a sensing signal from the sensor. In this way, the device can intelligently detect whether a ball has fallen and made contact with the housing, or whether a pet or person has touched the housing, and the driving member is activated to drive the ball-launching assembly only when mechanical vibrations of the housing are detected. Thus, energy consumption management is optimized, noise is reduced, and both the service life of the device and user experience are improved.

### BRIEF DESCRIPTION OF THE DRAWINGS

To better illustrate the technical solutions in the embodiments of the present disclosure or the prior art, a brief introduction to the drawings required in the description of the embodiments or the prior art is provided below. It is evident that the drawings described below are merely embodiments of the present disclosure. For those skilled in the art, other drawings can also be obtained based on the provided figures without any creative effort.

FIG. 1 is a schematic structural view of the sensing ball launcher according to one perspective of an embodiment of the present disclosure;

FIG. 2 is a schematic structural view of the sensing ball launcher according to another perspective of an embodiment of the present disclosure;

FIG. 3 is a top view of the sensing ball launcher according to an embodiment of the present disclosure;

FIG. 4 is a sectional view taken along line A-A in FIG. 3;

FIG. 5 is a schematic structural view of a part of the sensing ball launcher according to an embodiment of the present disclosure;

FIG. 6 is an exploded schematic view of a part of the sensing ball launcher according to an embodiment of the present disclosure;

FIG. 7 is an exploded schematic view of a ball feeding tube according to an embodiment of the present disclosure;

FIG. 8 is a bottom view of a chassis according to an embodiment of the present disclosure; and

FIG. 9 is a bottom view of a portion of the housing according to an embodiment of the present disclosure.

### REFERENCE NUMERAL

100—sensing ball launcher; 1—housing; a—ball entry port; b—ball exit port; c—ball feeding channel; o—avoidance hole; 11—ball feeding tube; 111—semi-tube; 12—chassis; e—arcuate recess; 2—ball-launching device; 21—ball-launching wheel; 22—wheel seat; f—wheel groove; 23—wheel cover; 3—vibration sensor; 4—controller; 5—ball-blocking assembly; 51—electric push rod; 52—blocking plate; 6—control panel; 7—switch; 8—battery; 9—ball guide funnel.

### DETAILED DESCRIPTION OF THE EXEMPLARY EMBODIMENTS

The technical solutions in the embodiments of the present disclosure will be clearly and completely described below in conjunction with the accompanying drawings of the embodiments of the present disclosure. It is evident that the described embodiments are only part of the embodiments of the present disclosure, and not all of the embodiments. All other embodiments obtained by those of ordinary skill in the art based on the embodiments of the present disclosure without creative effort shall fall within the protection scope of the present disclosure.

It should be noted that terms such as “center,” “longitudinal,” “lateral,” “upper,” “lower,” “front,” “rear,” “left,” “right,” “top,” “bottom,” “inner,” “outer,” “back,” “side,” and “circumferential,” etc., indicating directions or positional relationships, are based on the orientations or positional relationships shown in the drawings, and are merely for the convenience of describing the present disclosure and for simplification of the description, and are not intended to indicate or imply that the referenced devices or components must have a specific orientation or be constructed and operated in a specific orientation. Therefore, these terms should not be construed as limitations to the present disclosure. In addition, terms such as “first” and “second” are used only for the purpose of distinguishing multiple components or structures having the same or similar nature and do not imply any specific order of arrangement or connection.

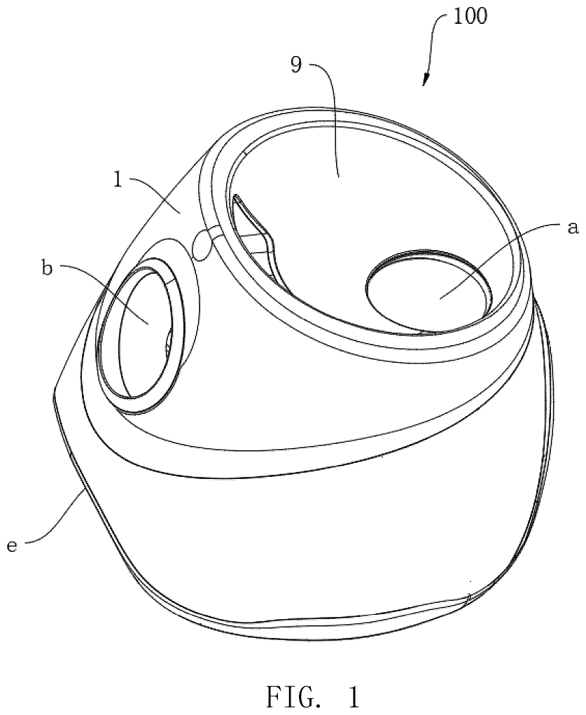

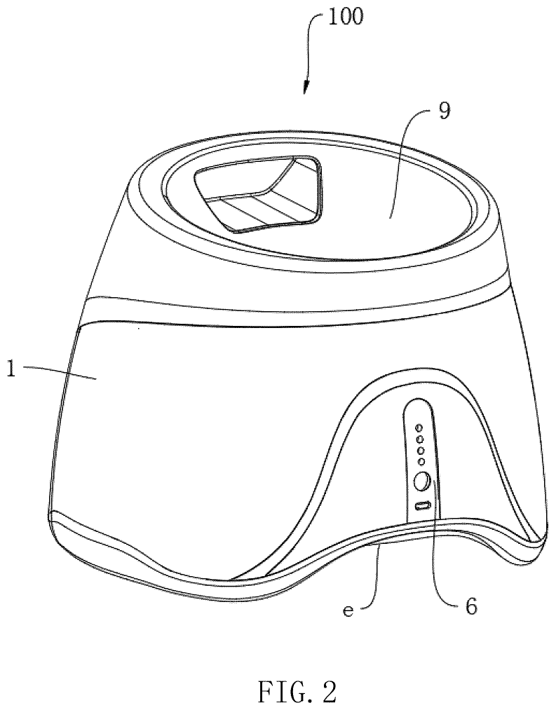

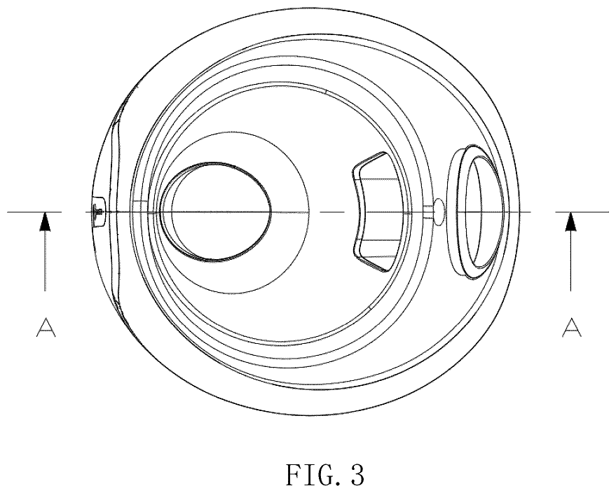

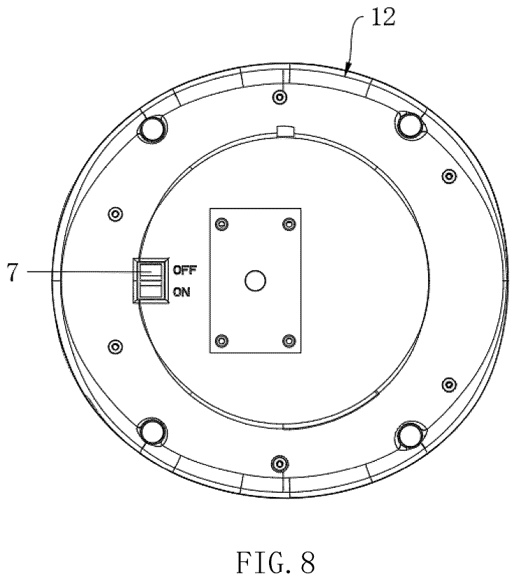

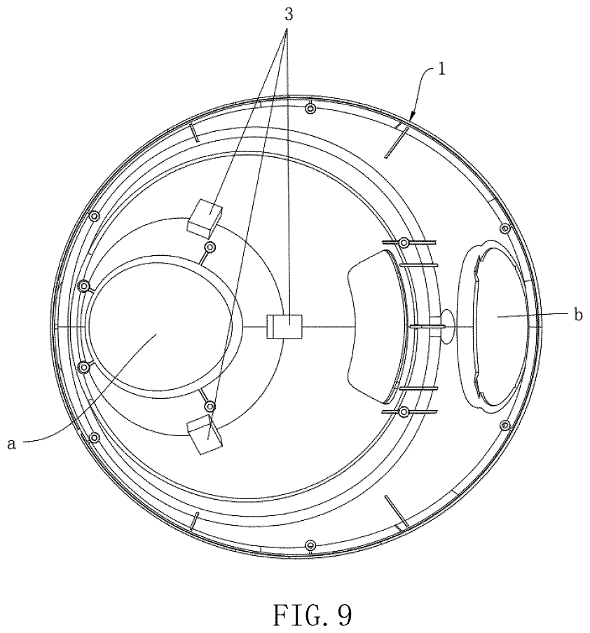

Referring to FIGS. 1 to 9, the embodiment of the present disclosure provides a sensing ball launcher 100, which includes: a housing 1, a ball-launching device 2, a first sensor, and a controller 4.

The housing 1 includes a ball entry port a, a ball exit port b, and a ball feeding channel c that is disposed inside the housing 1 and communicates the ball entry port a and the ball exit port b. The ball-launching device 2 is disposed inside the housing 1 and includes a driving member (not shown in the drawings) and a ball-launching assembly. The driving member is configured to provide power. The ball-launching assembly is mechanically coupled to the driving member and partially extends into the ball feeding channel c, and is configured to launch a ball from the ball exit port b. Optionally, the ball-launching assembly includes one or more ball-launching wheels 21 that squeeze and propel the ball to be launched from the ball exit port b. The first sensor is disposed on the housing 1 and configured to detect mechanical vibrations of the housing 1 caused by external forces. It is understood that the external forces may include, but are not limited to, a ball falling and making contact with the housing 1, or a pet or person touching the housing 1. Such external forces acting on the housing 1 will cause mechanical vibrations in the housing 1. The controller 4 is disposed in the housing 1, is signal-connected to the first sensor and electrically connected to the driving member, and is configured to control the operation of the driving member based on a sensing signal from the first sensor, thereby controlling the movement of the ball-launching assembly and the ball-launching action.

When the first sensor of the sensing ball launcher 100 detects mechanical vibrations of the housing 1 caused by external forces, the driving member starts to operate, thereby driving the ball-launching assembly to move and launch the ball through the ball feeding channel c from the ball exit port b.

When the first sensor does not detect mechanical vibrations of the housing 1 caused by external forces, the driving member remains in a non-operating state. In this way, the sensing ball launcher 100 can intelligently detect whether a ball has fallen and made contact with the housing 1, or whether a pet or person has touched the housing 1, and the driving member is activated to drive the ball-launching assembly only when mechanical vibrations of the housing 1 are detected. This optimizes energy consumption management, reduces noise, and improves both the service life of the device and user experience.

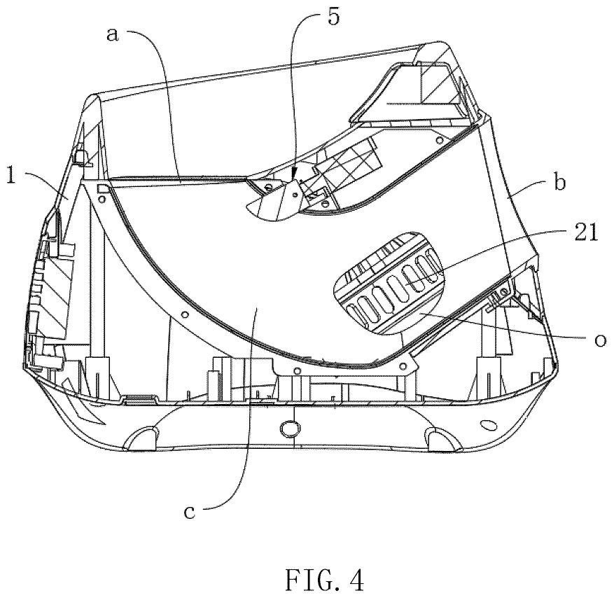

Optionally, referring to FIGS. 4 to 7 and FIG. 9, in this embodiment, the top of the housing 1 is provided with a ball guide funnel 9 having a diameter that gradually narrows from the edge toward the ball entry port a. The ball guide funnel 9 is configured to receive a ball and guide the ball to the ball entry port a. Certainly, in other embodiments, the ball guide funnel 9 may also be disposed at a side portion or an upper inclined portion of the housing 1, and no specific limitation is imposed herein.

The first sensor includes three vibration sensors 3 disposed on the inner wall of the ball guide funnel 9 and configured to sense mechanical vibrations caused by the falling of a ball. The three vibration sensors 3 are evenly spaced on the inner wall of the ball guide funnel 9 to better detect the entry of the ball. Certainly, in other embodiments, one, two, four, or more vibration sensors may be provided, and the vibration sensors 3 may also be disposed on the inner or outer sidewall of the housing 1. No specific limitation is imposed herein. Specifically, the vibration sensors 3 may optionally be vibration switches or piezoelectric vibration modules, without specific limitation.

For better interaction with pets, in the present embodiment, the sensing ball launcher 100 further includes an auxiliary remote controller (not shown in the drawings), which is signal-connected to the controller 4 and configured to remotely override and control the operation of the ball-launching device 2.

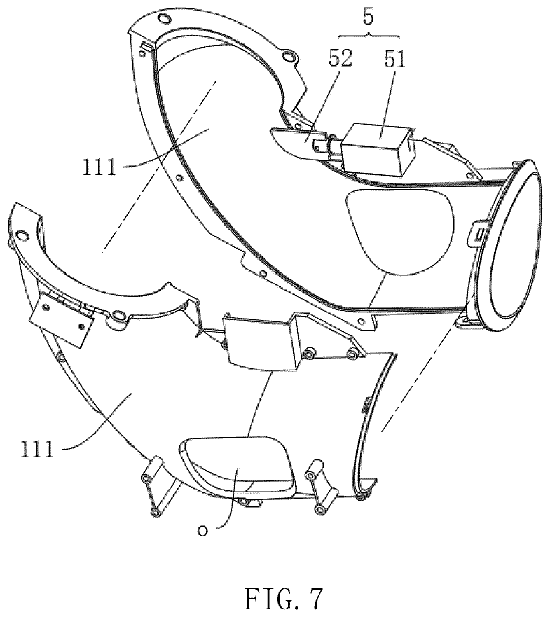

To avoid a situation where two balls consecutively enter the ball feeding channel c within a short period and cause the ball-launching assembly to become jammed, optionally, referring to FIGS. 4 and 7, in the present embodiment, a ball-blocking assembly 5 is further disposed inside the housing 1 at a position adjacent to the ball entry port a, and is electrically connected to the controller 4. The ball-blocking assembly 5 is configured to extend into the ball feeding channel c to block the passage of a ball, or to retract to allow the passage of a ball through. In this way, when the first sensor detects the passage of a ball, it sends a sensing signal to the controller 4, which simultaneously controls the operation of the driving member and causes the ball-blocking assembly 5 to extend into the ball feeding channel c to block the passage of a second ball. The controller 4 may be configured to delay for a preset period before retracting the ball-blocking assembly 5 to allow a ball to pass. Accordingly, the situation where two balls enter the ball feeding channel c consecutively and cause the ball-launching assembly to become jammed can be avoided.

Optionally, referring to FIGS. 4 and 7, in the present embodiment, the ball-blocking assembly 5 comprises an electric push rod 51 and a blocking plate 52. The electric push rod 51 is disposed inside the housing 1 and is electrically connected to the controller 4. The blocking plate 52 is fixedly connected to a push rod of the electric push rod 51, and a curved surface of an extending end of the blocking plate 52 matches a curved contour of an inner wall of the ball feeding channel c. In this way, by matching the curved surface of the blocking plate 52 with the contour of the inner wall of the ball feeding channel c, smooth contact is ensured with minimal extension and retraction travel, thereby enabling better control of ball conveyance and avoiding ball jamming or retention. Certainly, in other embodiments, the ball-blocking assembly 5 may also be implemented using a servo motor (not shown in the drawings), which is connected to the blocking plate 52 through a gear reduction box (not shown in the drawings) to achieve extension or retraction into or from the ball feeding channel c, thereby precisely controlling the passage of the ball. As long as the structure can achieve the function of extending into the ball feeding channel c to block the passage of a ball or, to retract to allow a ball to pass. No specific limitation is imposed herein.

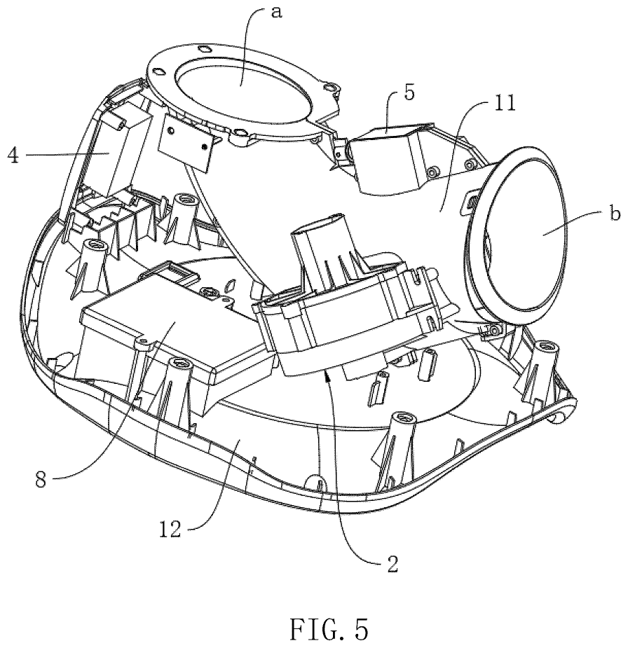

Optionally, referring to FIGS. 5 to 7, in the present embodiment, the ball-launching assembly comprises two ball-launching wheels 21. The two ball-launching wheels 21 are symmetrically disposed on two sides of the ball feeding channel c. The driving member comprises two driving motors (not shown in the drawings), each of which is mechanically coupled to one of the ball-launching wheels 21. The ball-launching wheels 21 partially extend into the ball feeding channel c to launch a ball from the ball exit port b. Specifically, avoidance holes o are formed on two sides of the ball feeding channel c, and portions of the ball-launching wheels 21 extend into the ball feeding channel c through the avoidance holes o. When a ball reaches the position of the two ball-launching wheels 21, the two ball-launching wheels 21 rotate to squeeze and propel the ball for launching. The ball-launching assembly includes two ball-launching wheels 21 symmetrically disposed on two sides of the ball feeding channel c, which can provide more uniform launching force and more stable ball speed.

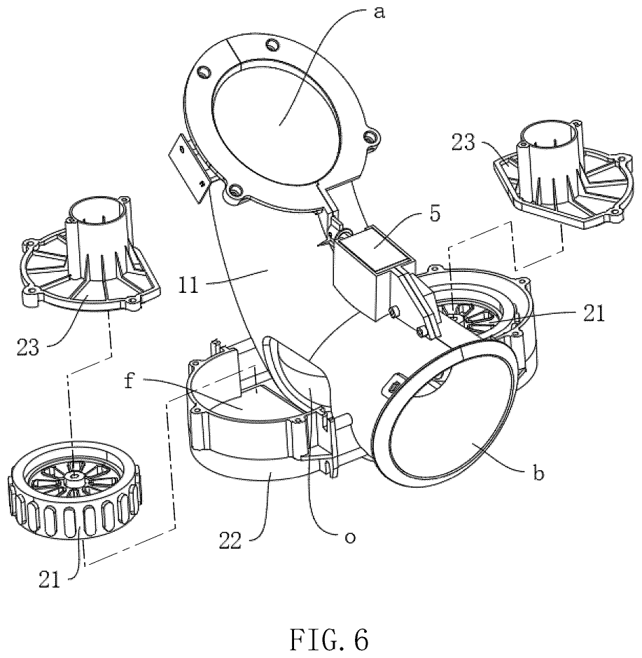

To achieve stable installation of the ball-launching wheels 21 and the driving motors, and to prevent external debris or dust from entering the area of the ball-launching wheels 21 and ensure their normal operation, optionally, referring to FIG. 6, in the present embodiment, the ball-launching device 2 further comprises: a wheel seat 22 and a wheel cover 23. The wheel seat 22 is mounted on an outer wall of the ball feeding channel c and comprises two wheel grooves f symmetrically provided on two sides of the ball feeding channel c for accommodating the ball-launching wheels 21. The wheel cover 23 is mounted over the wheel seat 22 and covers at least part of the ball-launching wheels 21. The driving motors are mounted outside the wheel cover 23, and their output ends pass through the wheel cover 23 and are fixedly connected to the ball-launching wheels 21 to drive the rotation of the ball-launching wheels 21. In this way, the ball-launching wheels 21 are stably rotatably disposed inside the wheel grooves f formed by the assembly of the wheel seat 22 and the wheel cover 23, preventing external debris or dust from entering the area of the ball-launching wheels 21 and affecting their normal operation.

To avoid launching a ball when an animal or pedestrian is present in the launching area of the ball exit port b of the sensing ball launcher 100, optionally, in the present embodiment, the sensing ball launcher 100 further comprises a second sensor (not shown in the drawings). The second sensor is disposed inside the housing 1 and is electronically connected to the controller 4, and is configured to sense whether a person or an animal is approaching the area of the ball exit port b. Specifically, the second sensor may be an infrared sensor, an ultrasonic sensor, or a radar sensor, without specific limitation.

To facilitate the manufacturing of the ball feeding channel c and its assembly with the housing 1, optionally, referring to FIGS. 6 and 7, in the present embodiment, the ball feeding channel c is a ball feeding tube 11 that is detachably mounted inside the housing 1. The ball feeding tube 11 is formed by splicing two symmetrical semi-tubes 111.

Optionally, referring to FIGS. 1, 2, and 4, the ball entry port a is disposed at an upper end of the housing 1, and the ball exit port b is disposed at a side of the housing 1. The ball feeding channel c extends downwardly from the ball entry port a and then upwardly to the ball exit port b. In this manner, the ball can reach the area having the ball-launching wheels 21 under the effect of gravity, reducing the need for additional transmission mechanisms and simplifying the overall structure. To facilitate ball loading, the upper end of the housing 1 is funnel-shaped, and a bottom portion of the funnel is connected to the ball entry port a. Optionally, a control panel 6 is disposed on a peripheral wall of the housing 1 opposite the side of the ball exit port b, to allow a user to control various functions of the sensing ball launcher 100. For example, different gear positions or modes can be selected to change the launching distance of the ball.

To prevent the chassis 12 of the sensing ball launcher 100 from having large-area contact with the ground and to avoid external moisture entering the housing 1 from the chassis 12, while also increasing the structural support strength of the chassis 12, optionally, referring to FIGS. 1, 2, and 8, in the present embodiment, the chassis 12 of the housing 1 has an upwardly protruding structure. An arcuate recess e that curves upwardly is provided on the peripheral wall of the housing 1 at the side of the ball exit port b and the control panel 6. In this way, only the edge of the chassis 12 contacts the ground, thereby reducing moisture ingress into the interior of the housing 1. Additionally, the upwardly protruding structure of the chassis 12 and the arcuate recess e formed on the peripheral wall of the housing 1 enhance the support strength of the housing 1. Further, a switch 7 may be disposed on a bottom surface corresponding to the protruding portion of the chassis 12 to prevent pets from accidentally touching and shutting off the sensing ball launcher 100.

Optionally, referring to FIG. 5, in the present embodiment, a battery 8 is also disposed inside the housing 1. The battery 8 supplies power to the ball-launching device 2, the first sensor, the controller 4, and the second sensor.

Finally, it should be noted that the above embodiments are merely for illustrating the technical solutions of the present disclosure and are not intended to limit the present disclosure. Although the present disclosure is described in detail with reference to the above embodiments, it will be understood by those skilled in the art that modifications to the technical solutions described in the foregoing embodiments, or equivalent substitutions for some or all of the technical features thereof, can be made without departing from the scope of the technical solutions of the embodiments of the present disclosure.

What is claimed is:

1. A sensing ball launcher, comprising:
a housing (1) having a ball entry port (a), a ball exit port (b), and a ball feeding channel (c) disposed inside the housing (1) and communicating the ball entry port (a) and the ball exit port (b);
a ball-launching device (2) disposed inside the housing (1) and comprising a driving member and a ball-launching assembly mechanically coupled to the driving member, wherein the ball-launching assembly partially extends into the ball feeding channel (c) and is configured to launch a ball from the ball exit port (b);
a first sensor disposed on the housing (1) and configured to detect mechanical vibrations of the housing (1) caused by external forces;
a controller (4) disposed inside the housing (1), signal-connected to the first sensor and electrically connected to the driving member, and configured to control a movement of the ball-launching assembly based on a sensing signal from the first sensor.

2. The sensing ball launcher according to claim 1, wherein the housing (1) comprises a ball guide funnel (9) having a diameter that gradually narrows from an edge toward the ball entry port (a), the ball guide funnel (9) is configured to receive a ball and guide the ball to the ball entry port (a); and
the first sensor is at least one vibration sensor (3) disposed on an inner wall of the ball guide funnel (9), and configured to sense mechanical vibrations caused by the falling of the ball.

3. The sensing ball launcher according to claim 2, further comprising an auxiliary remote controller, wherein the auxiliary remote controller is signal-connected to the controller (4) and configured to remotely override and control an operation of the ball-launching device (2).

4. The sensing ball launcher according to claim 1, wherein a ball-blocking assembly (5) is further disposed inside the housing (1) at a position adjacent to the ball entry port (a), and is electrically connected to the controller (4), wherein the ball-blocking assembly (5) is configured to extend into the ball feeding channel (c) to block the passage of a ball, or retract to allow the passage of a ball.

5. The sensing ball launcher according to claim 4, wherein the ball-blocking assembly (5) comprises:
an electric push rod (51) disposed inside the housing (1); and
a blocking plate (52) fixedly connected to a push rod of the electric push rod (51), wherein a curved surface of an extending end of the blocking plate (52) matches a curved contour of an inner wall of the ball feeding channel (c).

6. The sensing ball launcher according to claim 1, wherein the ball-launching assembly comprises two ball-launching wheels (21) symmetrically disposed on two sides of the ball feeding channel (c);
the driving member comprises two driving motors, and each of the two driving motors is mechanically coupled to one of the ball-launching wheels (21); and
the ball-launching wheels (21) partially extend into the ball feeding channel (c) to launch the ball from the ball exit port (b).

7. The sensing ball launcher according to claim 6, wherein the ball-launching device (2) further comprises:
a wheel seat (22) mounted on an outer wall of the ball feeding channel (c) and comprising two wheel grooves (f) symmetrically provided on two sides of the ball feeding channel (c) for accommodating the ball-launching wheels (21); and
a wheel cover (23) mounted over the wheel seat (22) and covering at least part of the ball-launching wheels (21);
wherein the driving motors are mounted outside the wheel cover (23), and output ends thereof pass through the wheel cover (23) and are fixedly connected to the ball-launching wheels (21).

8. The sensing ball launcher according to claim 1, further comprising a second sensor disposed inside the housing (1) and electronically connected to the controller (4), and configured to sense whether a person or an animal is approaching the ball exit port (b) region.

9. The sensing ball launcher according to claim 1, wherein the ball entry port (a) is disposed on an upper end of the housing (1), and the ball exit port (b) is disposed on a side of the housing (1); the ball feeding channel (c) extends downwardly from the ball entry port (a), and then upwardly to the ball exit port (b); a control panel (6) is disposed on a peripheral wall of the housing (1) at a side opposite to the ball exit port (b).

10. The sensing ball launcher according to claim 9, wherein a chassis (12) of the housing (1) has an upwardly protruding structure, and an arcuate recess (e) that curves upwardly is formed on the peripheral wall of the housing (1) at the side of the ball exit port (b) and the control panel (6).
